(19) United States
(12) Patent Application Publication
(10) Pub. No.: US 2023/0176443 A1
(43) Pub. Date: Jun. 8, 2023

(54) ACTIVE FLUIDIC OPTICAL ELEMENT

(71) Applicant: Meta Platforms Technologies, LLC, Menlo Park, CA (US)

(72) Inventors: Renate Eva Klementine Landig, Redmond, WA (US); Andrew John Ouderkirk, Kirkland, WA (US); Sheng Ye, Redmond, WA (US); Christopher Yuan Ting Liao, Seattle, WA (US); Jonathan Robert Peterson, Woodinville, WA (US); Nagi Hosni Elabbasi, Southborough, MA (US); Hongtao Guo, Redmond, WA (US); Hsin-Ying Chiu, San Jose, CA (US); Matthew James Hancock, Newton Highlands, MA (US); Li Yao, Redmond, WA (US)

(21) Appl. No.: 17/899,818

(22) Filed: Aug. 31, 2022

Related U.S. Application Data
(60) Provisional application No. 63/286,230, filed on Dec. 6, 2021.

(51) Int. Cl. G02F 1/29

(52) U.S. Cl. CPC G02F 1/29

(57) ABSTRACT

A fluidic optical element includes a fluid bilayer having a first fluid layer and a second fluid layer defining a fluid interface therebetween, and an electrode disposed over a surface of the fluid bilayer. The geometry of the fluid interface and hence the optical response of the fluid bilayer to incident light may be manipulated using the principle of dielectrophoresis.

### CROSS-REFERENCE TO RELATED APPLICATION

This application claims the benefit of priority under 35 U.S.C. §119(e) of U.S. Provisional Application No. 63/286,230, filed Dec. 6, 2021, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 shows example active fluidic optical elements having different top and bottom electrode configurations according to some embodiments.

FIG. 2 illustrates the operation of an active fluidic optical element including the reconfiguration of a fluid bilayer between paired electrodes and the formation of a periodic optical grating architecture according to some embodiments.

FIG. 3 illustrates the operation of an active fluidic optical element including the reconfiguration of a fluid bilayer overlying a single electrode and the sinusoidal modulation of the fluid interface according to certain embodiments.

FIG. 4 shows the effect of fluid wave amplitude at normal incidence on the transmission of different diffraction orders according to some embodiments.

FIG. 5 illustrates the operation of an active fluidic optical element including the reconfiguration of a fluid bilayer disposed between paired electrodes and the sinusoidal modulation of the fluid interface according to certain embodiments.

FIG. 6 illustrates a comparison between an optical element having a single electrode and an optical element having paired electrodes on the amplitude of the sinusoidal modulation of the fluid interface for a given applied voltage according to certain embodiments.

FIG. 7 shows continuous tuning of the amplitude of sinusoidal interface modulation with applied voltage according to various embodiments.

FIG. 8 shows the effect of shifting a top structured electrode with respect to a bottom structured electrode on the shape of a fluid interface according to some embodiments.

FIG. 9 shows the effect of biasing individually-addressable electrodes on the shape of a fluid interface according to further embodiments.

FIG. 10 illustrates the effect of a blazed grating on first order diffraction modes according to certain embodiments.

FIG. 11 depicts the formation of fluid columns using a periodic electrode configuration according to some embodiments.

FIG. 12 shows the effect of the inter-electrode spacing on the geometry of the fluid columns of FIG. 11 according to certain embodiments.

FIG. 13 shows the impact of changing the lateral offset between top and bottom electrode arrays on the tilt angle of fluid columns according to some embodiments.

FIG. 14 shows the impact of changing electrode dimensions on the shape of fluid columns according to various embodiments.

FIG. 15 illustrates the modulation of a fluid interface along two in-plane directions according to some embodiments.

FIG. 16 shows the effects of gravity on a vertically-oriented active fluidic optical element according to some embodiments.

FIG. 17 shows pulse width modulation and pulse code modulation paradigms according to some embodiments.

FIG. 18 shows the impact of changing modulation wavelength on the transient turn on time for example fluidic optical elements according to certain embodiments.

FIG. 19 is a plot of contact angle versus applied voltage showing continuous tuning of the contact angle according to some embodiments.

FIG. 20 shows perspective views of a fluidic prism for (A) unbiased and (B) biased states according to various embodiments.

FIG. 21 shows continuous tuning of the interface angle of the fluidic interface with applied voltage according to various embodiments.

FIG. 22 is an illustration of exemplary augmented-reality glasses that may be used in connection with embodiments of this disclosure.

FIG. 23 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Actively and continuously tunable fluidic optical elements may be incorporated into the optical aperture of an optical device such as a head-mounted display, where such optical elements may be used, for example, for free space beam steering, to form or constitute a transmission surface relief grating, or to provide input/output coupling for a waveguide.

According to some embodiments, an active fluidic optical element may include a fluid bilayer that is disposed over an electrode or between an electrode pair. The bilayer may include first and second fluid layers that define a fluid interface or boundary therebetween. An index of refraction of a first fluid within the first fluid layer may be unequal to an index of refraction of a second fluid within the second fluid layer. In an unbiased state, where an electrode or electrode pair is located approximately parallel to the fluid layers, individual fluid layers may have an average thickness ranging from approximately 0.1 micrometer to approximately 5 micrometers, e.g., approximately 0.1 micrometer, approximately 0.2 micrometer, approximately 0.5 micrometer, approximately 1 micrometer, approximately 2 micrometers, or approximately 5 micrometers, including ranges between any of the foregoing values. In an unbiased state, where an electrode or electrode pair is located approximately orthogonal to the fluid layers, individual fluid layers may have an average thickness ranging from approximately 5 micrometers to approximately 1000 micrometers, e.g., approximately 5 micrometers, approximately 50 micrometers, approximately 200 micrometers, approximately 500 micrometers, or approximately 1000 micrometers, including ranges between any of the foregoing values.

By applying a voltage to the one or more electrodes, the geometry of the fluid interface and hence the optical response of the fluid bilayer to incident light may be manipulated using the principle of dielectrophoresis. By way of example, under the influence of an applied voltage, the fluid layers may be configured to form a periodic grating of alternating first and second fluid layers. The pitch of such a grating may be tunable continuously or in discrete steps, with the step size depending on the electrode configuration. The grating pitch may be spatially uniform or spatially non-uniform. In some embodiments, a fluidic optical element may be configured to form a prism. The prism apex angle may be tunable continuously or in discrete steps in 1 or 2 dimensions by moving the three phase contact line using the principle of dielectrowetting. In some embodiments, a fluidic optical element may be configured in an array of plural fluidic optical elements. An active fluidic optical element may be disposed over a transparent substrate or sandwiched between transparent substrates.

The applied voltage may be constant or variable (i.e., pulsed) and may be characterized by one or more of a duty cycle, pulse width, pulse shape, amplitude, etc. The pulse shape may be determined by the fluid dynamics, and driven such that it decreases transient times or compensates for physical effects. Implementation of a pulsed voltage may decrease the overall power consumption of an optical element. An example pulse shape may be rectangular, although further pulse shapes are contemplated. In some examples, a duty cycle of a pulse may be less than 100%. A duty cycle may be temporally variable, such as with pulse-code modulation.

A transparent substrate may be planar or non-planar and may have a thickness of less than approximately 500 micrometers, e.g., less than approximately 400 micrometers, or less than approximately 300 micrometers. A substrate may include electrical via interconnects and/or bonding pads for integration with one or more additional components, such as an integrated circuit driver. Example substrate materials include fused silica, quartz, sapphire, highly crystalline thermoplastics such as polyesters or highly crystalline polycarbonates, and highly crosslinked thermoset materials such as highly cross-linked acrylates, epoxies, or urethanes.

According to various embodiments, the composition of first and second fluid layers may be independently selected from polyphenyl ether, polyphenyl thioether, silicone oil, a fluorinated fluid, and water, although additional dielectric and conductive media are contemplated. Small molecules may be added to a polyphenyl ether or polyphenyl thioether, e.g., diiodomethane or oligomers. The first and second fluids may be mutually immiscible, whereas the respective fluids may exhibit a large difference in each of their index of refraction and dielectric permittivity.

According to further embodiments, one or both of the fluid layers may be replaced by a low-modulus gel. That is, a fluidic optical element may include a fluid/fluid, fluid/gel, or gel/gel architecture. A low-modulus gel may be characterized by an elastic modulus of less than approximately 50 kPa, e.g., less than 10 kPa, or less than 1 kPa. A gel may contain nanoparticles that are configured to increase the refractive index difference and/or to increase the dielectric permittivity difference between the two fluid layers. Example nanoparticles may include BaTiO₃, ZnO, ZrO₂, TiO₂, ZnS, Nb₂O₅, SiO₂, Si, as well as combinations thereof.

A gel may include a crosslinked three-dimensional polymer network containing a large amount of liquid solvent or other fluid. Examples of such gels may have a dielectric constant of at least approximately 10, e.g., 10, 20, 30, 40, or 50, including ranges between any of the foregoing values.

A crosslinked polymer network may be formed from prepolymers through heat- or photo-curing in the presence of a photo- or thermal catalyst. Example prepolymers include acrylates, acrylamides, acryloylmorpholines and derivatives, methacrylates, methacrylamides, methacryloylmorpholines and derivatives, polyols with isocyanates, and their derivatives, polysulfides with isocyanates and their derivatives, polythioethers and their derivatives, silicones and their derivatives, and crosslinkable ionic liquids, such as 1-butyl-3-vinylimidazolium bis(trifluoromethanesulfonyl)imide, and its derivatives. Polar functional groups, such as fluorinated groups, esters, thioketones, amides, or pyridine groups and their derivatives, may be incorporated into the polymer network to increase the dielectric constant of the polymer network. Example liquid solvents/fluids include water, aliphatic or aromatic compounds, or ionic liquids having a dielectric constant of at least approximately 5, e.g., 5, 10, 20, 30, 40, or 50, including ranges between any of the foregoing values. A fluid may include fluorinated groups, esters, thioketones, amides, or pyridine groups or their derivatives, for example.

According to further embodiments, a gel may include a crosslinked three-dimensional polymer network containing a large amount of liquid solvent or other fluid, where the dielectric constant is less than approximately 10, e.g., less than 5 or less than 2. Such a crosslinked polymer network may be formed from prepolymers through heat- or photo-curing in the presence of a photo- or thermal catalyst.

Example prepolymers include acrylates, acrylamides, acryloylmorpholines and derivatives, methacrylates, methacrylamides, methacryloylmorpholines and derivatives, polyols with isocyanates, and their derivatives, polysulfides with isocyanates and their derivatives; polythioethers and their derivatives, and silicones and their derivatives. Example liquid solvents/fluids include aliphatic or aromatic compounds having a dielectric constant of less than approximately 10, e.g., less than 5 or less than 2. Particular examples include silicone oils and mineral oils.

According to still further embodiments, a gel may include a solvent-free polymer network with a high-density of high molecular weight side chains attached to a polymer backbone. Examples include bottlebrush polymer elastomers having a dielectric constant of at least approximately 10, e.g., 10, 20, 30, 40, or 50, including ranges between any of the foregoing values. The polymer backbone may be aliphatic or aromatic, and ionic or charge-neutral.

The backbone of a solvent-free polymer network may include, for example, polynorbornene (PNB), poly(meth)acrylate (P(M)MA), polymethacrylamide, polystyrene (PS), polyacetone, polypeptides, polythiophene, polysaccharides, silicone, and other compounds. Side chains may include polystyrene, polyacrylate, polyglycol, polylactide, P3HT, crosslinkable ionic liquids, for example 1-butyl-3-vinylimidazolium bis(trifluoromethanesulfonyl)imide, or copolymers including combinations of those segments, and their derivatives. Additional polar functional groups, including fluorinated groups, esters, thioketones, amides, or pyridine groups or their derivatives, may be incorporated into the polymer network to increase the dielectric constant of the polymer network.

A gel may include a solvent-free polymer network with a high-density of high molecular weight side chains attached to a polymer backbone. Examples include bottlebrush polymer elastomers, where the dielectric constant is less than approximately 10, e.g., less than 5 or less than 2.

The backbone of a solvent-free polymer network may be aliphatic or aromatic, and ionic or charge-neutral, and may include polynorbornene (PNB), poly(meth)acrylate (P(M)MA), polymethacrylamide, polystyrene (PS), polyacetone, polypeptides, polythiophene, polysaccharides, silicone, and the like. Side chains may include polystyrene, polyacrylate, polyglycol, polylactide, P3HT, crosslinkable ionic liquids, for example 1-butyl-3-vinylimidazolium bis(trifluoromethanesulfonyl)imide, or copolymers including combinations of those segments, and their derivatives.

According to further embodiments, in the example of a gel/gel structure, one of the gel layers may be replaced by a gas. Example gases include, but are not limited to, Ar, N₂, Kr, Xe, O₂, SF₆, CHF₃, CF₄, C₂F₆, C₃F₈, air, as well as mixtures thereof. A gas may increase resistance to dielectric breakdown while also increasing the index of refraction difference between the two layers. The two fluid layers in a gel/gas structure may be mutually immiscible, having a large difference in each of their index of refraction and dielectric permittivity.

In some embodiments, the solubility of the two fluids (i.e., liquids or gases) or a fluid and a gel with respect to each other may be less than approximately 1 g/100 g, e.g., less than approximately 0.1 g/100 g, or less than approximately 0.01 g/100 g. In certain embodiments, the density difference between the two fluids may be less than approximately 20%, e.g., less than approximately 10%. Comparable fluid densities may inhibit or prevent gravity sag in devices where the fluid bilayer is oriented vertically. In other embodiments, the density difference may be greater, e.g., at least approximately 20%, at least approximately 50%, at least approximately 100%, or at least approximately 200%. The first and the second fluids may have a refractive index difference of at least approximately 0.1 at 550 nm, e.g., at least approximately 0.1, at least approximately 0.2, at least approximately 0.3, or at least approximately 0.4, including ranges between any of the foregoing values. The difference in dielectric permittivity between the two fluids may be greater than approximately 50%, e.g., greater than 100%, 200%, 300%, 400% or 500%.

The electrode(s) may include one or more electrically conductive materials, such as a metal (e.g., silver nanowires), a semiconductor (e.g., a doped semiconductor), a conductive polymer, carbon nanotubes, graphene, oxidized graphene, fluorinated graphene, hydrogenated graphene, other graphene derivatives, carbon black, transparent conductive oxides (TCOs, e.g., indium tin oxide (ITO), zinc oxide (ZnO), etc.), or other electrically conducting materials. In some embodiments, the electrodes may include a metal such as aluminum, gold, silver, platinum, palladium, nickel, tantalum, tin, copper, indium, gallium, zinc, alloys thereof, and the like.

Further example transparent conductive oxides include, without limitation, aluminum-doped zinc oxide, tin oxide, fluorine-doped tin oxide, indium-doped cadmium oxide, indium oxide, indium zinc oxide, indium zinc tin oxide, indium gallium tin oxide, indium gallium zinc oxide, indium gallium zinc tin oxide, strontium vanadate, strontium niobate, strontium molybdate, and calcium molybdate.

The electrodes may have any suitable geometry. Segmented electrodes, for example, may have a uniform or non-uniform shape, including varying widths where the local dimensions may be based on location within a device. Top and bottom segmented electrodes may be co-extensive or offset (i.e., shifted laterally with respect to each other). In various embodiments, floating electrodes may have smaller dimensions than connected electrodes. In some embodiments, the electrodes may have a thickness of approximately 1 nm to approximately 1000 nm, with an example thickness of approximately 10 nm to approximately 50 nm.

Plural electrodes may be combined into groups either dynamically or during a design phase. In example methods, the electrodes may be driven independently or multiplexed. Plural electrodes may be individually addressable, including with respect to a time profile, amplitude, etc.

Plural segmented electrodes may be configured as an array of electrical conductors of a pre-defined shape arranged in a pre-defined pattern such as on a line (e.g., a 1xN array), a rectangular grid (e.g., a MxN array), or a non-rectangular grid such as elements on a curve, spiral pattern, concentric circles, etc. Electrical passivation elements may be disposed between the electrodes to decrease leakage.

In an example method, the applied voltage to various electrode segments may change polarity each time the device is turned on, for example with a timescale of approximately 200 Hz to approximately 10 kHz.

In some embodiments, a layer of a solid dielectric material may be interposed between the fluid bilayer and one or more of the electrodes. The solid dielectric layer may be configured to attenuate the electric field produced across the fluid bilayer under the effects of an applied voltage and accordingly effect the shape of the actuated fluid interface.

A solid dielectric layer may include any suitable dielectric material, including organic and inorganic compositions. Example dielectric materials include photoresist, HfO₂, Si₃N₄, SiO₂, TiO₂, Nb₂O₅, etc. In some embodiments, a dielectric layer may have a thickness of less than approximately 2 micrometers, e.g., less than 1 micrometer, or less than 0.5 micrometer. A solid dielectric layer may be characterized as a homogeneous layer or as an inhomogeneous layer, for example, including two or more dielectric materials having different dielectric permittivities. A solid dielectric layer may be optically transparent. A difference in the index of refraction between a solid dielectric layer and an adjacent electrode may be less than approximately 0.2 at 550 nm, e.g., less than approximately 0.2, less than approximately 0.15, or less than approximately 0.1.

The wettability of the first and second fluid layers and the formation of first and second fluid layers each having a substantially constant equilibrium thickness may be improved by incorporating a surface modification layer between the fluid bilayer and one or both of the two solid surfaces that are in direct contact with each respective fluid layer. That is, each solid surface (e.g., electrode or solid dielectric layer) may be coated with a material that favors wetting of one fluid over the other. In an example configuration, a surface that favors arrangement of the first fluid may exhibit a wetting angle of less than 20°, e.g., less than 10°, with the first fluid, and a wetting angle of greater than 50°, e.g., greater than 60° with the second fluid, whereas the other surface may favor arrangement of the second fluid and may exhibit a wetting angle of less than 20°, e.g., less than 10°, with the second fluid, and a wetting angle of greater than 50°, e.g., greater than 60° with the first fluid. There may be a different degree of bonding (i.e., ionic bonding and/or hydrogen bonding) and/or polarity differential between the fluid layers as well as between each fluid layer and its respective solid surface. In some embodiments, an antireflective layer may be incorporated into an active optical element, such as between a fluid layer and an adjacent solid surface.

In some embodiments, an active fluidic optical element may include a surface modification layer. A surface modification layer may include a discrete layer (thin film) or may be characterized as a surface treatment of a solid surface. A thin film or surface treatment may be used to modify the hydrophilicity and/or oleophilicity of a solid surface, for example.

Example surface modification layers may include a benzyl-containing silane, such as benzyl triethoxy silane, phenethyl trimethoxy silane, tolyl trimethoxy silane, methoxy phenyl triethoxy silane, diphenyl dimethoxy silane, diphenyl diethoxy silane, and the like. A hydroxyl-containing silane or an ionic silane, such as a silane containing sodium salt, ammonium chloride salt, or ammonium bromide salt, may be applied to the solid surface contacting water. A fluorinated silane or a fluorinated polymer may be applied to the solid surface contacting a fluorinated fluid. Example surface treatments may include ozone or UV light exposure.

In some embodiments, a fluid layer (e.g., a first fluid layer and/or a second fluid layer) may include a surfactant. Particularly suitable surfactants may include amphiphilic compounds. In such examples, hydrophilic functional groups may be selected from hydroxyl, carboxyl, carbonyl, amino, phosphate, and sulfhydryl groups. Further example hydrophilic functional groups may include anionic groups such as sulfate, sulfonate, carboxylate, and phosphate groups. Example hydrophobic functional groups may be selected from aliphatic, aromatic, and fluorinated groups. In a fluidic optical element including phenyl silicone oil and water as a fluid pair, a surfactant may include an aromatic functional group and a hydroxyl (or amino or ionic) functional group. Through the addition of a surfactant, the interfacial surface tension of the fluids within the bilayer may be less than approximately 35 dynes/cm, e.g., less than approximately 30 dynes/cm, or less than approximately 25 dynes/cm.

Various driving schemes may be used to apply a bias to the one or more electrodes. In some examples, an electrode may be driven with an AC voltage at less than approximately 100 kHz to avoid chemical decomposition (i.e., oxidation) of the fluids and inhibit charge buildup. The AC frequency may be selected depending on the conductivity of the fluids and may be greater than approximately 30 kHz so as to be outside the audible range for human hearing. In certain embodiments where the first and second fluids are insulating with conductivities of less than approximately 1×10⁻¹² S/cm, e.g., less than approximately 10⁻¹³ S/cm, DC operation may be used. In further embodiments, an AC current having a frequency in the range of approximately 100 Hz to approximately 100 kHz may be used.

In some embodiments, the modulation of the fluid interface/boundary may be monitored and controlled using self-capacitance sensing. This may be implemented by measuring the capacitance between a drive electrode and ground. Alternatively, the mutual capacitance may be measured between adjacent electrodes by modulating the AC waveform on one electrode and detecting the magnitude of the AC-coupled, modulated signal on the other electrode.

According to still further embodiments, the actuation state may be monitored/controlled by measuring the charge applied to an electrode, measuring the current sourced by the voltage driver, or measuring the impedance from an electrode to ground or between adjacent electrodes. For instance, the charge, current, self-capacitance, and/or impedance of one or more electrodes may be measured during actuation.

Sensing may be performed on all electrodes or a subset of electrodes. Additionally, the sensing may be time division multiplexed (i.e., sequenced) or measured in parallel (i.e., simultaneously). Sparse sensing of a limited number of electrodes may improve the measurement rate allowing for faster feedback. Sparse sensing interpolation, such as linear interpolation, may be performed between measurement points. A sensed value may be correlated to a degree of actuation (e.g., pillar or wave displacement) and used for real-time feedback to provide accurate control of the fluid geometry.

In some embodiments, LCD (liquid crystal display) technology may be leveraged to manufacture an active fluidic optical element. By way of example, an electrode, e.g., a transparent electrode such as an ITO electrode may be formed over the inner surfaces of a cell. To create and maintain a uniform cell gap, for instance, a layer of acrylic or resin may be shaped into a spacer on one or both sides of a cell. A spacer may be sized as shaped according to the application. A sealant process may be applied to encapsulate the fluid within the cell. A sealing layer may be configured to inhibit evaporation and/or contamination of the fluid. In some examples, a form factor of the optical element may be adjusted, such as by thinning of a glass layer, which may benefit wearability.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

Features from any of the embodiments described herein may be used in combination with one another in accordance with the general principles described herein. These and other embodiments, features, and advantages will be more fully understood upon reading the following detailed description in conjunction with the accompanying drawings and claims.

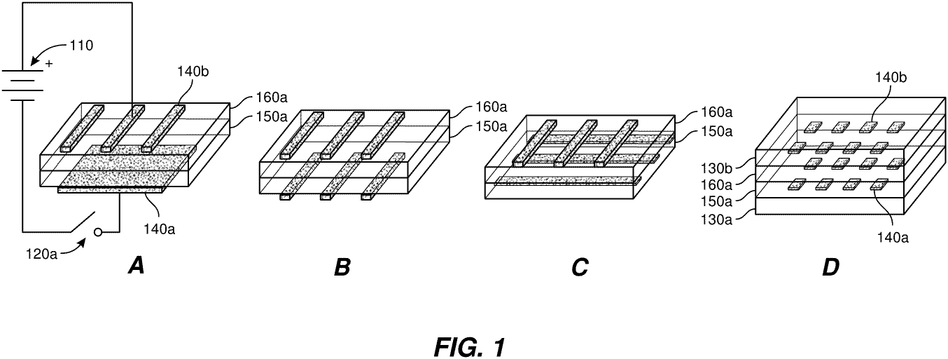

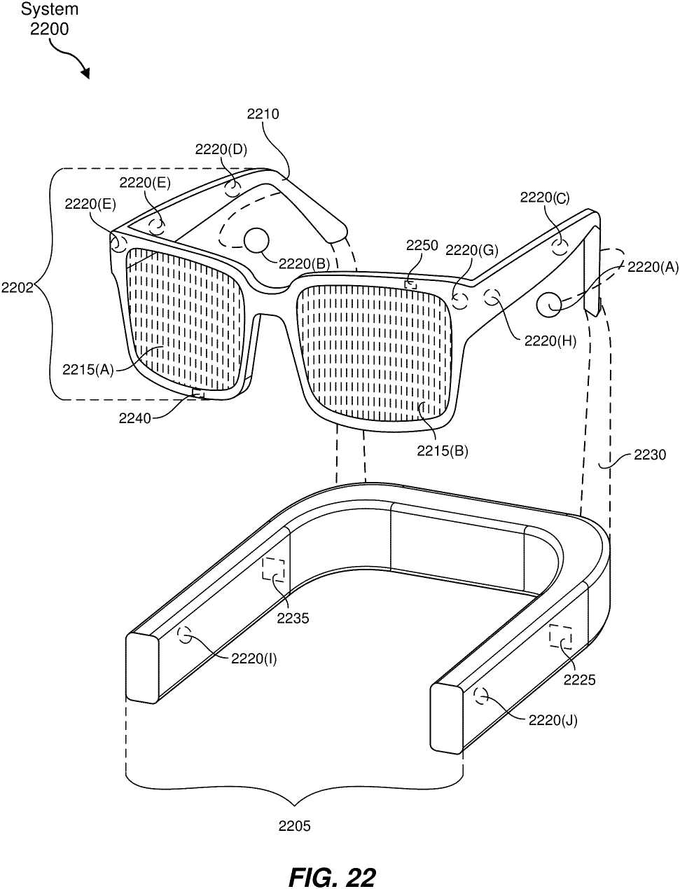

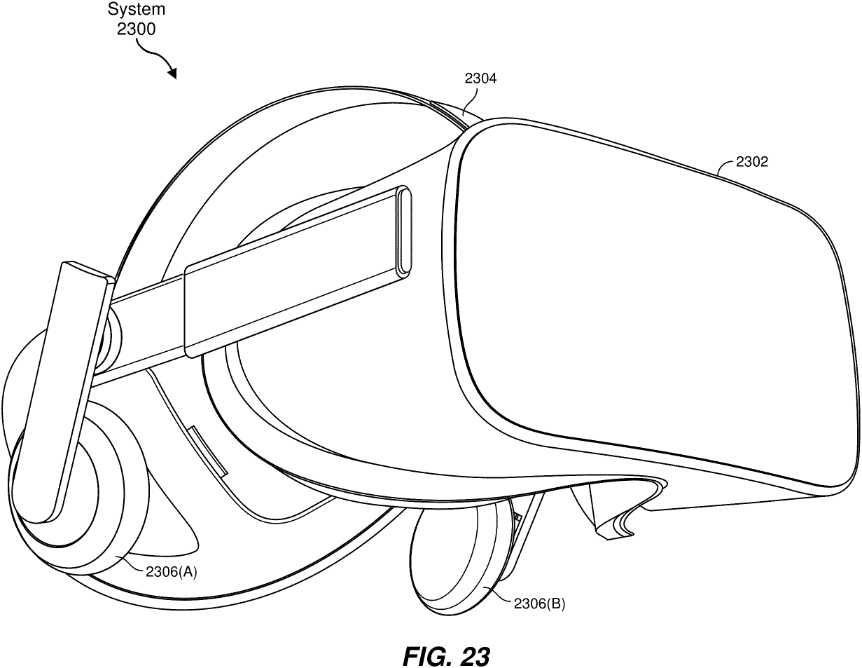

The following will provide, with reference to FIGS. 1-23, a detailed description of example active fluidic optical elements and their methods of manufacture. The discussion associated with FIGS. 1-21 relates to example optical element architectures and various principles of operation. The discussion associated with FIGS. 22 and 23 relates to exemplary virtual reality and augmented reality devices that may include one or more active fluidic optical elements.

Referring to FIG. 1, illustrated are example active fluidic optical elements having different configurations of paired electrodes. In FIGS. 1A-1D, the active fluidic optical elements each include a fluid bilayer having a first fluid layer 150a in contact with a second fluid layer 160a, where the fluid bilayer is sandwiched between a first electrode layer 140a and a second electrode layer 140b.

Referring to FIG. 1A, a fluidic optical element includes a planar bottom electrode layer 140a and an overlying patterned top electrode layer 140b each connected to voltage source 110. In one alternate configuration, top and bottom electrodes may include co-extensive linear (1D) arrays (FIG. 1B). In a further alternate configuration, top and bottom electrodes may include askew linear (1D) arrays (FIG. 1C). Referring to FIG. 1D, top and bottom electrodes may include patterned 2D arrays. In the embodiment of FIG. 1D, a bottom dielectric layer 130a may be disposed over the first fluid layer 150a and the first electrode layer 140a, and a top dielectric layer 130b may be disposed over the second fluid layer 160a and the second electrode layer 140b. Top and bottom electrodes may be collectively or individually addressed (or unaddressed). In some embodiments, the fluidic volumes may be switched using an active matrix backplane or a passive matrix backplane. Flexible backplanes made from organic thin film transistors and stretchable interconnects may also be used.

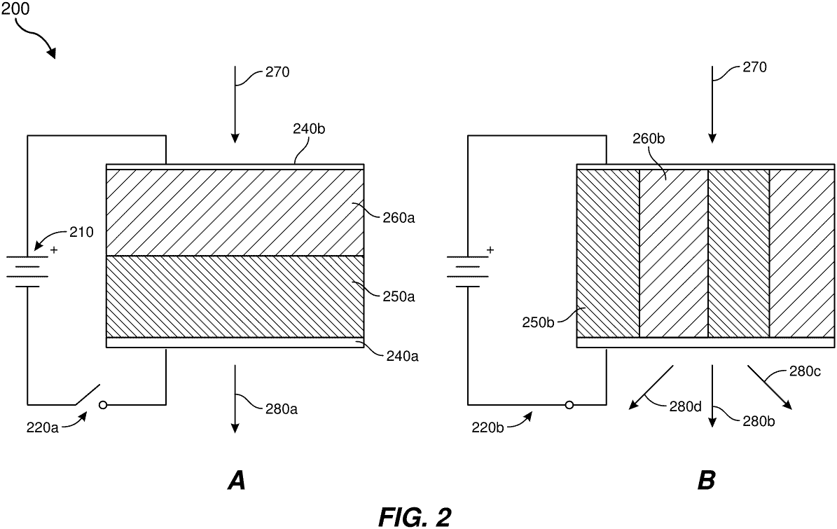

Referring to FIG. 2, shown is a schematic cross-sectional view of an active fluidic optical element according to some embodiments. The active fluidic optical element 200 includes a fluid bilayer having a first fluid layer 250a and a second fluid layer 260a directly overlying the first fluid layer 250a. Bottom and top planar electrodes 240a, 240b are respectively disposed over a surface of the first and second fluid layers 250a, 260a, and are electrically connected to power supply 210.

Referring to FIG. 2A, in an unbiased state with the power off (220a) an example input light ray 270 may be transmitted through the optical element and emerge as an un-diffracted or substantially un-diffracted output light ray 280a. Referring to FIG. 2B, with the power on (220b), an instability at the fluid interface may reconfigure first and second fluid layers 250a, 260a as aligned columnar structures 250b, 260b that may bridge the interelectrode gap and form a binary phase grating. The grating period may correspond to an instability wavelength determined by system parameters, including the gap dimensions, the dielectric constants of the fluid layers, the applied voltage, etc. Accordingly, input light ray 270 may be diffracted at the binary phase grating. Output light rays are shown schematically, including zeroth order output light ray 280b and first order output light rays 280c, 280d.

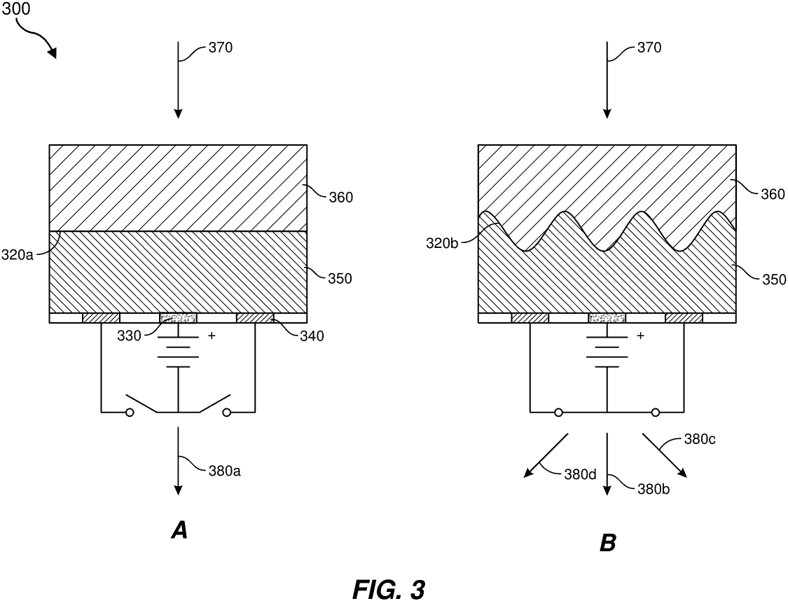

Referring to FIG. 3, shown is a schematic cross-sectional view of a further active fluidic optical element. Active fluidic optical element 300 includes a fluid bilayer having a first fluid layer 350 and a second fluid layer 360 directly overlying the first fluid layer 350. The fluid bilayer overlies a structured electrode having ground element 330 and powered elements 340.

In an unbiased state, as shown in FIG. 3A, an input light ray 370 may be transmitted through the optical element, including unperturbed fluid interface 320a, and emerge as an un-diffracted or substantially un-diffracted output light ray 380a. Referring to FIG. 3B, when a bias is applied to the structured electrode, competition between surface tension and electrostatic forces may create a sinusoidal modulation in fluid interface 320b, which may approximate a sinusoidal phase grating modulation, where the modulation amplitude to wavelength ratio is less than approximately 3, e.g., less than approximately 1, with higher harmonics increasingly included with greater modulation amplitudes. That is, the applied voltage may induce a 3-dimensional conformal modification of the fluid interface and generate a desired optical response.

In the illustrated embodiment, the dielectric permittivity of first fluid layer 350 may be greater than the dielectric permittivity of second fluid layer 360 such that the first fluid layer may be preferentially attracted by the higher electric field gradients between the electrodes. Accordingly, input light ray 370 may be diffracted at the sinusoidal phase grating and emerge as output light rays, including zeroth order output light ray 380b and first order output light rays 380c, 380d.

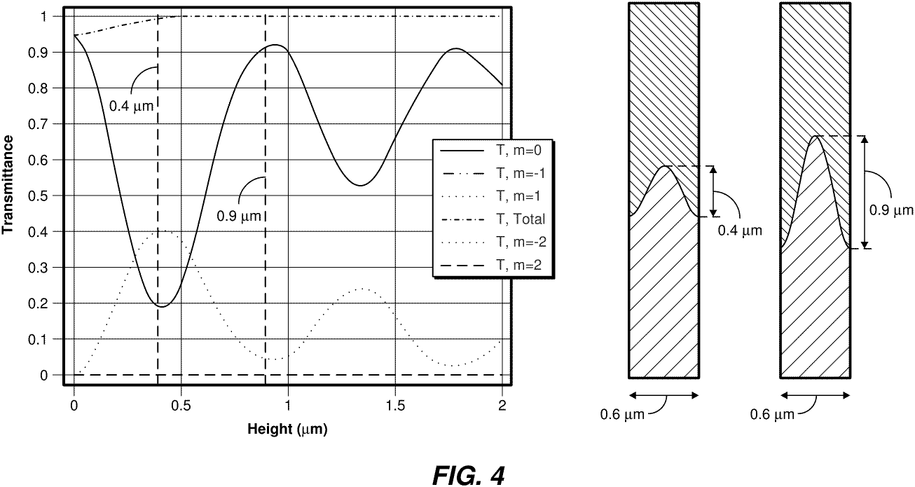

Turning to FIG. 4, in the example of sinusoidal modulation, shown schematically is the effect of the amplitude of the modified fluid interface on the transmission of different diffraction orders for normal incidence.

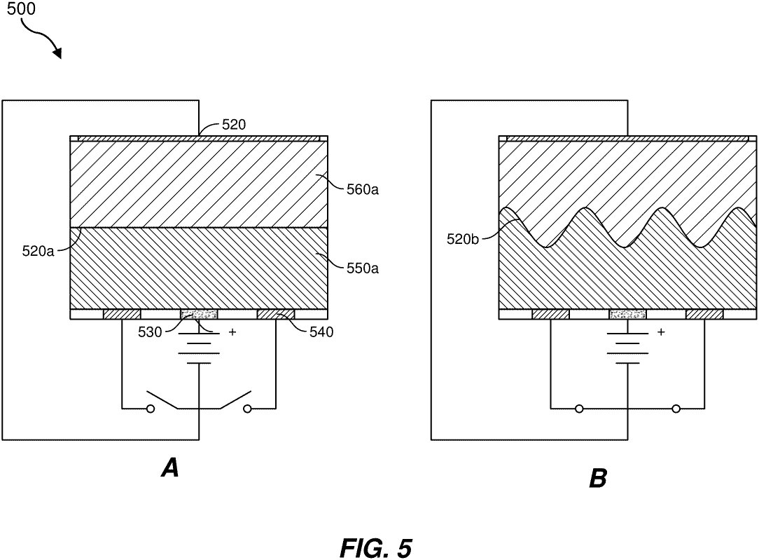

A further example active fluidic optical element is shown in FIG. 5. Referring initially to FIG. 5A, active fluidic optical element 500 may include a fluid bilayer having a first fluid layer 550a and a second fluid layer 560a directly overlying the first fluid layer 550a. The fluid bilayer is disposed between lower and upper electrodes. Lower electrode may include a structured electrode having ground element 530 and powered elements 540, and upper electrode may include a planar electrode 520. In an unbiased state, fluid interface 520a between the first and second fluid layers 550a, 560a may be planar or substantially planar.

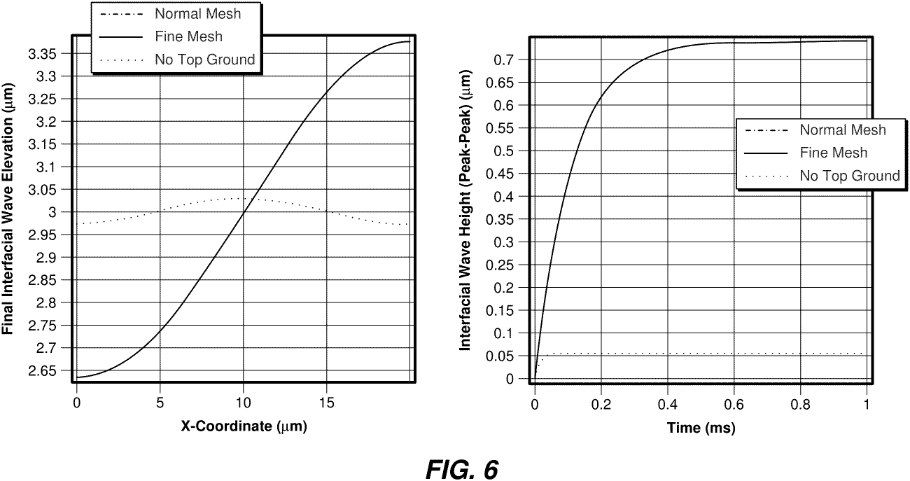

Locating the fluid bilayer between lower and upper electrodes may result in a doubling of the wavelength of the interface modulation relative to the embodiment shown in FIG. 3, where the higher dielectric permittivity fluid (e.g., first fluid layer 550a) may be drawn to where the parallel plate contribution to the electric field is strongest. Thus, referring to FIG. 5B, under an applied bias, surface tension and electrostatic forces may create a sinusoidal modulation in fluid interface 520b. The incorporation of the top electrode may, for a given applied voltage, increase the amplitude of the sinusoidal modulation, as shown in FIG. 6.

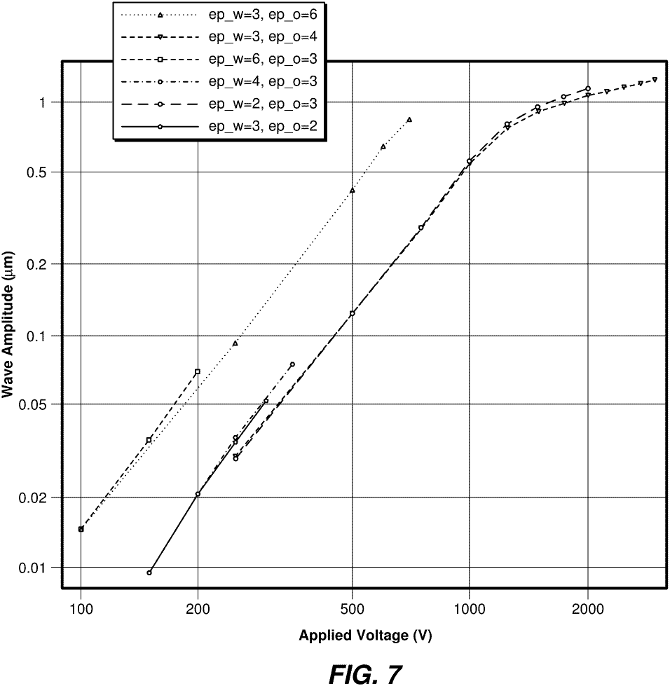

With the amplitude of the sinusoidal interface scaling as the difference in the dielectric permittivities of the first and second fluid layers, FIG. 7 shows that the amplitude of the sinusoidal interface modulation may be continuously tuned as a function of the applied voltage.

The wave amplitude may be limited in many cases by the dielectric breakdown of one of the involved fluids. That is, electrohydrodynamics is primarily driven by the electric field gradient experienced across the fluid interface. In some embodiments, the wave amplitude may be increased by decreasing the surface tension at the fluid interface.

A surfactant may be added to one or both of the fluid layers. However, such an approach may induce longer transients. In particular, the turn-off transient, where the fluid interface reverts to a planar state, is driven by the surface tension alone and may be limited by fluid viscosities. In one approach, in lieu of simply turning off the electric field, the interface may be more quickly driven back to a planar or substantially planar state by applying an electric field that actively drives the system towards the planar configuration. Thus, in an exemplary embodiment, the electric field is not turned off immediately, but switched to an out of phase configuration that accelerates fluid redistribution by forcing the fluid to flow from maximum to minimum locations.

According to further embodiments, the wave amplitude may be increased by incorporating a solid dielectric layer between the fluid bilayer and at least one of the electrodes. By adding a solid dielectric layer within the high-field region immediately adjacent to an electrode, the fluid layers may be subject to a smaller absolute electric field. A still further approach to increasing the wave amplitude may include configuring the fluidic optical element to have a non-planar interface in the unbiased state.

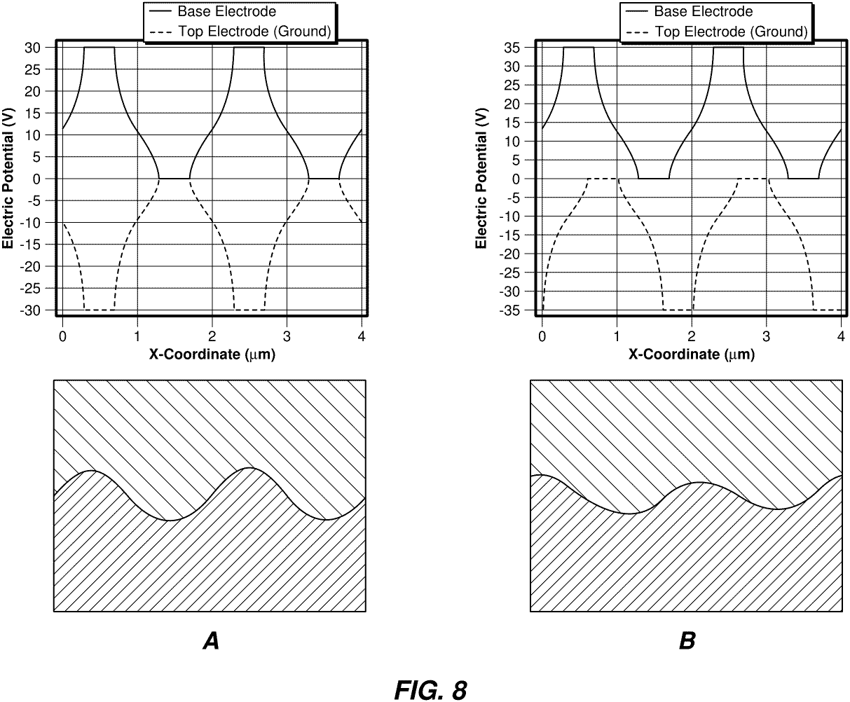

FIG. 8 shows that the modulation maxima across a fluid interface may be shifted by translating (i.e., misaligning) a top structured electrode with respect to a bottom structured electrode. Additionally, this architecture may be used to introduce asymmetry to the shape of the modulation of the fluid interface. The spatial offset may be defined during manufacture or may be adjustable. An edge transducer, for example, may be configured to translate the top structured electrode with respect to the bottom structured electrode and provide a dynamic inter-electrode array offset.

A dynamic offset may facilitate real-time tuning of the fluid asymmetry and an associated adjustment of the optical properties of the fluidic optical element. In some examples, the achievable asymmetry and hence the range of the optical response for a dynamic system may be greater than the asymmetry and response attainable for a fixed configuration. This may be achieved by decreasing the driving voltage, e.g., by at least approximately 5%, as the top and bottom electrodes are displaced with respect to each other.

By way of example, and with reference initially to FIG. 8A, bottom and top structured electrodes are co-extensive, whereas in FIG. 8B, the top electrode is shifted by approximately one third of the inter-electrode spacing, resulting in a related shift of the interface modulation maxima and an attendant introduction of an asymmetry away from sinusoidal. In this embodiment, the top structured electrodes are at one potential, and the bottom structured electrodes are at a different potential.

In a further embodiment, the structured electrodes may be individually addressable and driven to different electric potentials to allow the formation of a target modulation wavelength and modulation asymmetry. In yet another embodiment, the electric potentials may be temporally offset to facilitate the formation of the target modulation wavelength and modulation asymmetry.

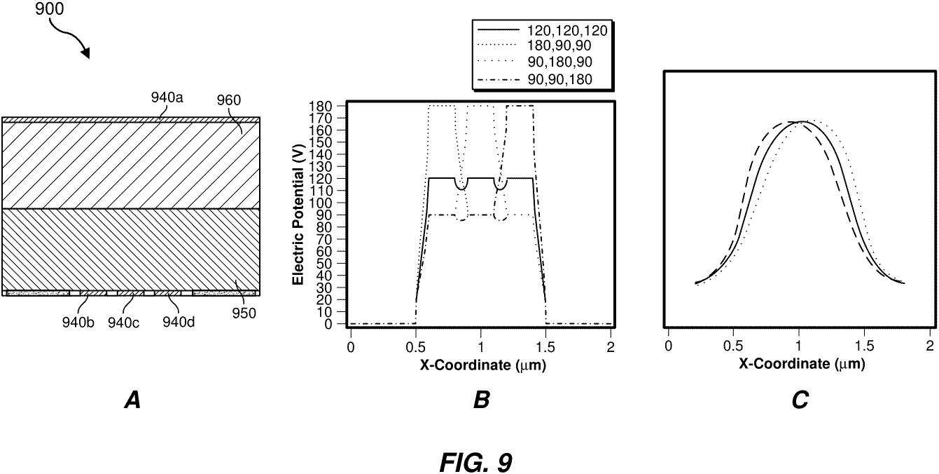

Referring to FIG. 9, shown schematically is a further embodiment related to shifting modulation maxima. In the embodiment of FIG. 9, an active fluidic optical element 900 includes a fluid bilayer having a first fluid layer 950 and a second fluid layer 960 collectively sandwiched by a bottom electrode and a top electrode. The top electrode 940a may include a planar electrode, and the bottom electrode may include individually addressable electrodes 940b, 940c, and 940d.

The potential applied to electrodes 940b, 940c, and 940d is shown in FIG. 9B for different examples. The application of different voltages may be used to shift the maxima of the interfacial modulation, as depicted in FIG. 9C.

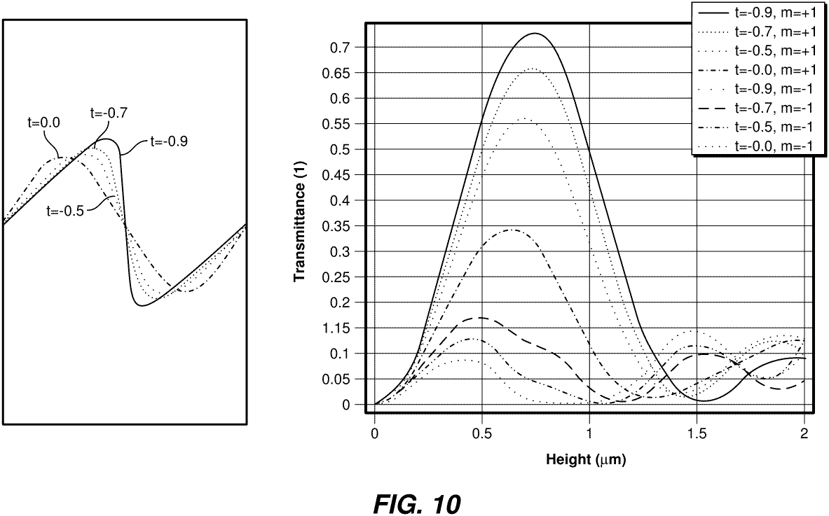

According to further embodiments, modulation asymmetry may be introduced to increase diffraction efficiency into a certain diffraction order. FIG. 10 shows an example illustrating how a blazed grating may change the two first order diffraction modes, favoring diffraction into the +1^{st} order over the -1^{st} order.

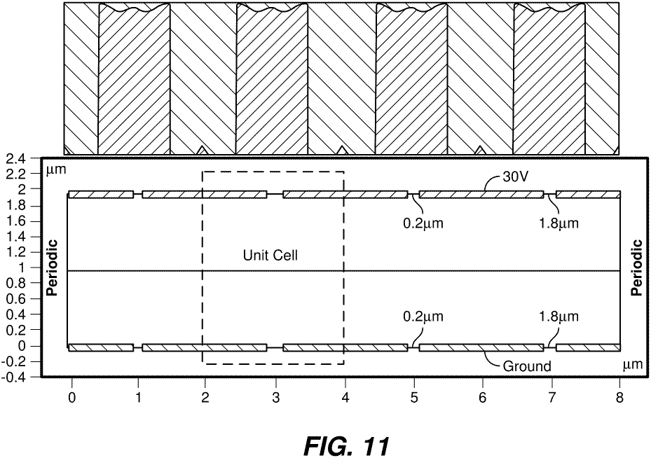

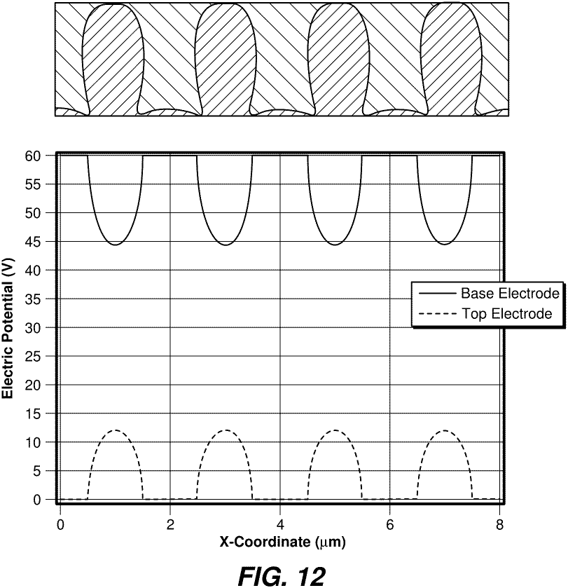

Referring to FIG. 11, illustrated is an example embodiment where the fluid layers form columns instead of finite stable wave amplitudes. The periodic electrode configuration for this case is also shown. In addition, by changing the electrode width while keeping the spacing between the center of neighboring electrodes fixed, the shape of the individual fluid columns can also be controlled, as shown in FIG. 12.

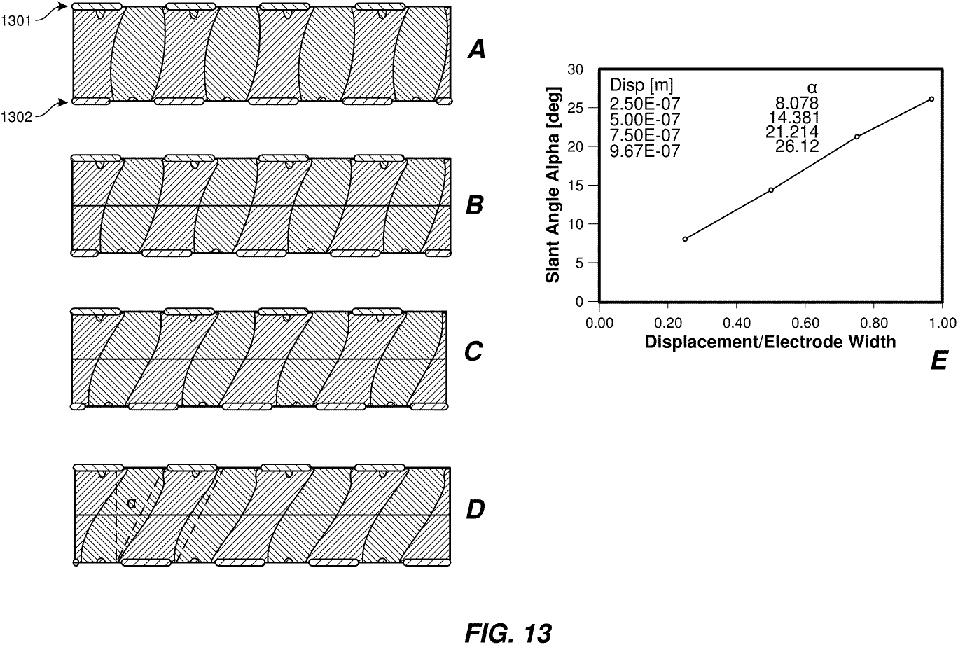

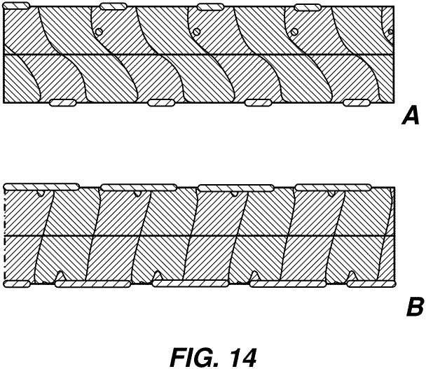

Referring to FIG. 13, asymmetric fluid columns may be formed by offsetting the top electrode array 1301 with respect to the bottom electrode array 1302. Moreover, with reference to FIGS. 13A-13D, an angle of inclination (α) of the fluid columns may be increased by increasing the lateral offset between the top and bottom electrode arrays 1301, 1302. A plot of the tilt angle (α) with respect to a normalized inter-electrode displacement is shown in FIG. 13E. In addition, by changing the electrode width while keeping the spacing fixed between the center of neighboring electrodes, the shape of the individual columns can be controlled, as shown in FIGS. 14A and 14B.

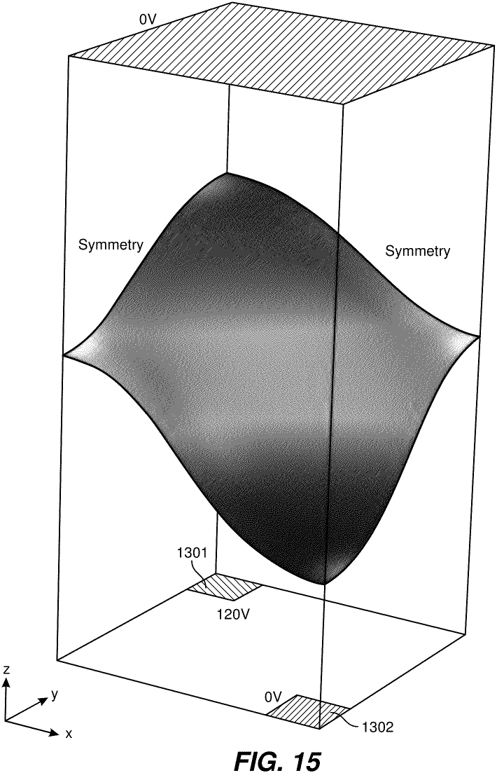

FIG. 15 illustrates an embodiment where the electrode placement results in a fluid wave profile that is modulated along two in-plane directions. Planes of symmetry on all four side faces are shown for reference. A voltage may be applied to electrode 1501, whereas electrode 1502 may be kept at zero potential. Other placements of the electrodes can also achieve the same fluid wave profile. In the illustrated embodiment, the wavelength along both in-plane directions (x and y) is the same, but it may be varied.

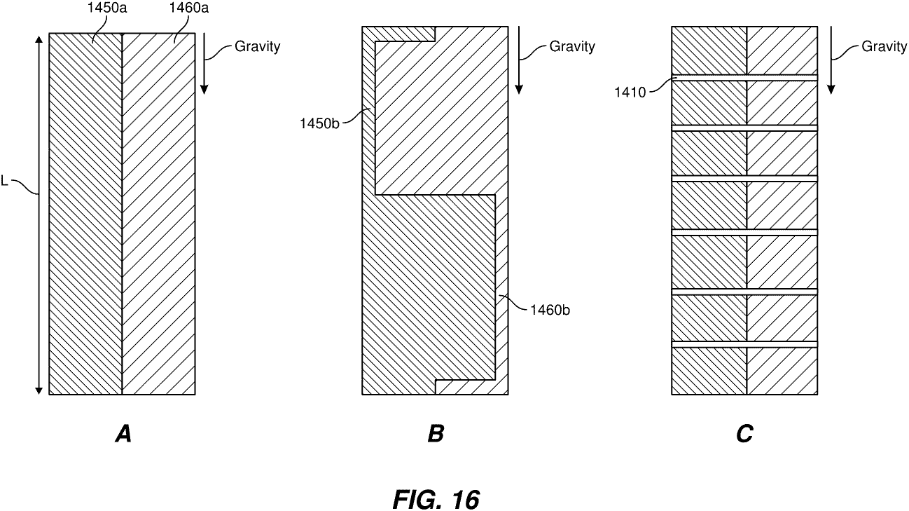

The effect of gravity on a vertically-oriented fluid bilayer is shown in FIG. 16 for different embodiments. As will be appreciated, gravity drain of the heavier fluid may lead to a non-uniform intralayer and/or interlayer thickness. A desired state is shown in FIG. 16A, where first fluid layer 1650a and second fluid layer 1660a are arranged parallel to the axis of gravity and each have a substantially constant thickness.

Referring to FIG. 16B, a density mismatch between the two fluid layers may give rise to a drainage phenomenon where the heavier fluid migrates downward causing a sagging interface. Only a thin coating 1650b of the first fluid and a thin coating 1660b of the second fluid remain in select regions of the redistributed bilayer. Without wishing to be bound by theory, if the vertical size of the fluid volume is small, both surface tension and interfacial tension may dominate inertial forces. On the other hand, for larger systems, e.g., L > 5 mm, undesirable drainage may occur for fluids such as water and oil.

Referring to FIG. 16C, according to some embodiments, shown is the incorporation of one or more partitions 1610 into the fluid volume. The partitions may be planar or non-planar and may be configured to inhibit the redistribution of fluids under the effect of gravity away from a desired state (FIG. 16A) and toward an undesired state (FIG. 16B). Each partition may be optically transparent and of any suitable geometry. An inter-partition spacing may be less than approximately 10 mm, e.g., less than 5 mm, for example.

In certain embodiments, gravity may be compensated by a vertical voltage gradient. Such a voltage may increase (decrease) along the direction of gravity if a lighter fluid has a higher (lower) relative permittivity compared to a heavier fluid. This voltage gradient may be superposed on local voltage variations. A reset protocol could also be envisioned where only the voltage gradient would be applied to equalize layer thickness, e.g., upon system startup.

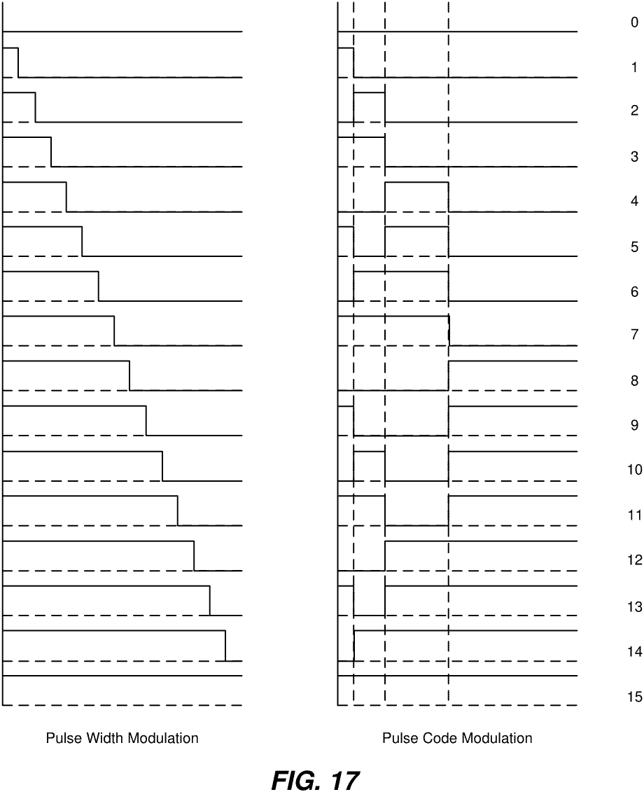

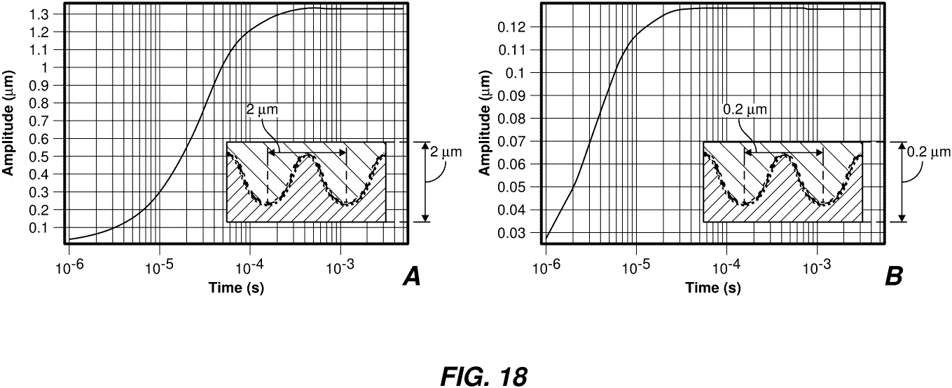

Schematic illustrations of pulse width modulation and pulse code modulation paradigms suitable for controlling a fluidic optical element are shown in FIG. 17. Referring to FIG. 18, depicted are plots that show the effect of changing the modulation wavelength on the transient turn on time for example fluidic optical elements. In some embodiments, the transient turn on time scales with the pitch of the modulation.

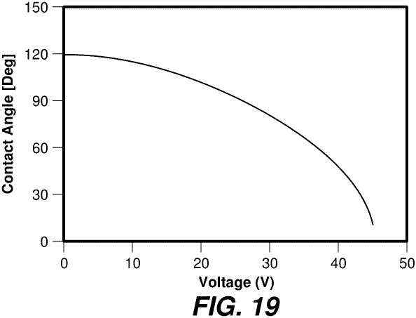

The effect of dielectrowetting and the continuous tuning of the contact angle of a dielectric fluid subject to an inhomogeneous electric field is shown in FIG. 19. The wetting angle of a droplet directly overlying a surface of an electrode array may be decreased by applying a voltage to the electrode array. In some examples, the droplet may be encapsulated by a second immiscible fluid. Changes in the wetting angle may change the three phase contact line.

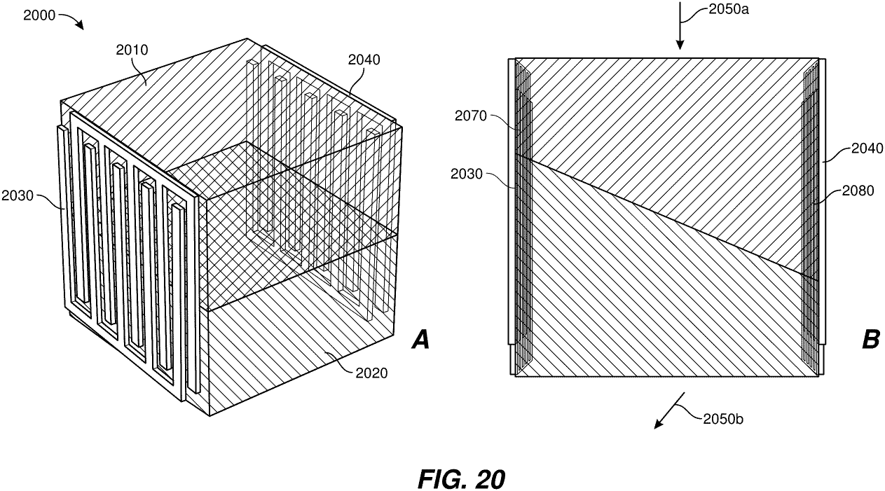

Turning to FIG. 20, shown is a perspective view of a further active fluidic optical element. Referring initially to the unbiased state of FIG. 20A, active fluidic optical element 2000 includes a fluid bilayer having a first fluid layer 2010 and a second fluid layer 2020 directly underlying the first fluid layer 2010. Opposing interdigitated electrodes 2030 and 2040 are located on two sides of the device. The fluid surfaces facing the interdigitated electrodes may be coated by a solid dielectric layer and may further have a coating that favors wetting of the fluid with the higher dielectric permittivity layer. A static wetting angle of the higher dielectric permittivity fluid may be greater than 90°, e.g., greater than 110° or greater than 130°.

In a biased state, as shown in FIG. 20B, the fluidic interface may be substantially planar except within regions 2070, 2080 proximate to the electrodes, thus forming a fluidic prism. In the depicted embodiment, the prism apex angle may be adjustable by applying different voltages to the electrode arrays 2030 and 2040 in such a way that the sum of the wetting angles on both sides totals 180°. An input light ray 2050a may be transmitted through the fluidic prism, and emerge as a refracted output light ray 2050b.

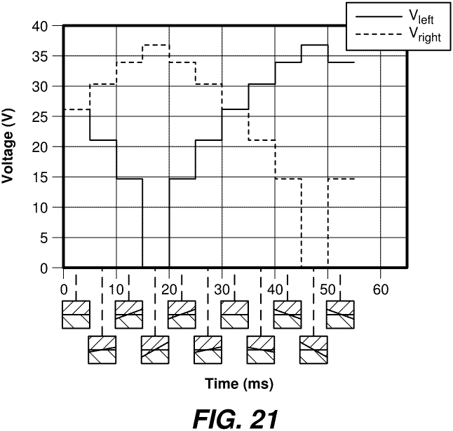

Referring to FIG. 21, according to an exemplary embodiment, applying certain combination of voltages on the left and right electrode arrays 2030 and 2040 may be used to create a continuous change in the apex angle of the fluidic prism.

As disclosed herein, an active optical element includes an electroded fluid bilayer. The bilayer may include first and second fluid layers defining a fluid interface therebetween. Under the influence of a voltage applied to one or more electrodes, the resulting electric field may induce a conformal change in the shape of the fluid interface and an attendant modification in the optical response of the fluid bilayer to incident light. Such an active optical element may be continuously tunable and operable, e.g., as an optical grating, using the principle of dielectrophoresis acting on the fluid interface.

An optical element may include a single electrode or paired electrodes sandwiching the fluid bilayer. The electrode(s) may be optically transparent and may have a blanket or patterned geometry. In some examples, paired electrodes may wholly or partially overlap, or may be laterally offset. The respective fluid layers may include any suitable dielectric media and may be characterized by comparable densities, yet disparate indices of refraction and dielectric permittivity. Example liquid fluids may include polyphenylethers, benzenes, silicone oils, and water.

In some embodiments, a solid dielectric layer may be interposed between the fluid bilayer and one or more of the electrodes. The solid dielectric layer may be configured to attenuate the electric field produced across the fluid bilayer under the effects of an applied voltage and accordingly effect the shape of the fluid interface. The applied voltage may be constant or variable (i.e., pulsed) and may be characterized by one or more of a duty cycle, pulse width, pulse shape, amplitude, etc.

In some examples, an active optical element may be incorporated into a display system, such as a head-mounted display for augmented reality or virtual reality devices. The presently-disclosed active optical elements may, for example, provide free space beam steering, form or constitute a transmission surface relief grating, or provide input/output coupling for a waveguide.

### EXAMPLE EMBODIMENTS

Example 1: A fluidic optical element includes a fluid bilayer having a first fluid layer and a second fluid layer defining a fluid boundary therebetween, and a first electrode layer disposed over a surface of the fluid bilayer.

Example 2: The fluidic optical element of Example 1, where the first fluid layer includes a first liquid selected from a polyphenylether, 1,3-bis(phenylthio)benzene, and silicone oil and the second fluid layer includes a second liquid selected from water and silicone oil.

Example 3: The fluidic optical element of Example 2, where the first liquid and the second liquid are substantially immiscible.

Example 4: The fluidic optical element of any of Examples 2 and 3, where a refractive index difference between the first liquid and the second liquid is at least approximately 0.1.

Example 5: The fluidic optical element of any of Examples 1-4, where at least one of the first fluid layer and the second fluid layer includes a surfactant.

Example 6: The fluidic optical element of any of Examples 1-5, further including a partition structure separating the fluid bilayer into a plurality of fluid chambers.

Example 7: The fluidic optical element of any of Examples 1-6, where the first electrode layer is optically transparent.

Example 8: The fluidic optical element of any of Examples 1-7, where a thickness of the first electrode layer ranges from approximately 10 nm to approximately 50 nm.

Example 9: The fluidic optical element of any of Examples 1-8, where the first electrode layer directly overlies the first fluid layer.

Example 10: The fluidic optical element of any of Examples 1-9, where the first electrode layer includes a continuous coating.

Example 11: The fluidic optical element of any of Examples 1-9, where the first electrode layer includes a segmented coating.

Example 12: The fluidic optical element of any of Examples 1-9, where the first electrode layer is configured as an array of discrete electrode segments.

Example 13: The fluidic optical element of Example 12, where two or more of the electrode segments are independently connected to a respective voltage source.

Example 14: The fluidic optical element of any of Examples 12 and 13, where floating electrode segments have areal dimensions less than areal dimensions of electrode segments connected to a voltage source.

Example 15: The fluidic optical element of any of Examples 1-14, further including a solid dielectric layer disposed over the first electrode layer.

Example 16: The fluidic optical element of any of Examples 1-15, further including a second electrode layer disposed over a surface of the fluid bilayer opposite to the first electrode layer.

Example 17: The fluidic optical element of Example 16, where the second electrode layer is configured as an array of discrete electrode segments.

Example 18: The fluidic optical element of any of Examples 1-17, where the fluid bilayer is disposed between transparent substrates.

Example 19: A fluidic optical element includes a primary electrode, a secondary electrode overlapping at least a portion of the primary electrode, and a fluid bilayer including a first fluid layer and a second fluid layer disposed between and abutting the primary electrode and the secondary electrode.

Example 20: A method includes forming a fluid bilayer between a primary electrode and a secondary electrode, the fluid bilayer including a first fluid layer and a second fluid layer defining a fluid boundary therebetween having a first shape, and applying a voltage across the fluid bilayer in an amount effective to change the first shape of the fluid boundary to a second shape and modify an optical response of the fluid bilayer.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without neareye displays (NEDs). Other artificial-reality systems may include an NED that also provides visibility into the real world (such as, e.g., augmented-reality system 2200 in FIG. 22) or that visually immerses a user in an artificial reality (such as, e.g., virtual-reality system 2300 in FIG. 23). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 22, augmented-reality system 2200 may include an eyewear device 2202 with a frame 2210 configured to hold a left display device 2215(A) and a right display device 2215(B) in front of a user’s eyes. Display devices 2215(A) and 2215(B) may act together or independently to present an image or series of images to a user. While augmented-reality system 2200 includes two displays, embodiments of this disclosure may be implemented in augmented-reality systems with a single NED or more than two NEDs.

In some embodiments, augmented-reality system 2200 may include one or more sensors, such as sensor 2240. Sensor 2240 may generate measurement signals in response to motion of augmented-reality system 2200 and may be located on substantially any portion of frame 2210. Sensor 2240 may represent one or more of a variety of different sensing mechanisms, such as a position sensor, an inertial measurement unit (IMU), a depth camera assembly, a structured light emitter and/or detector, or any combination thereof. In some embodiments, augmented-reality system 2200 may or may not include sensor 2240 or may include more than one sensor. In embodiments in which sensor 2240 includes an IMU, the IMU may generate calibration data based on measurement signals from sensor 2240. Examples of sensor 2240 may include, without limitation, accelerometers, gyroscopes, magnetometers, other suitable types of sensors that detect motion, sensors used for error correction of the IMU, or some combination thereof.

In some examples, augmented-reality system 2200 may also include a microphone array with a plurality of acoustic transducers 2220(A)-2220(J), referred to collectively as acoustic transducers 2220. Acoustic transducers 2220 may represent transducers that detect air pressure variations induced by sound waves. Each acoustic transducer 2220 may be configured to detect sound and convert the detected sound into an electronic format (e.g., an analog or digital format). The microphone array in FIG. 22 may include, for example, ten acoustic transducers: 2220(A) and 2220(B), which may be designed to be placed inside a corresponding ear of the user, acoustic transducers 2220(C), 2220(D), 2220(E), 2220(F), 2220(G), and 2220(H), which may be positioned at various locations on frame 2210, and/or acoustic transducers 2220(I) and 2220(J), which may be positioned on a corresponding neckband 2205.

In some embodiments, one or more of acoustic transducers 2220(A)-(J) may be used as output transducers (e.g., speakers). For example, acoustic transducers 2220(A) and/or 2220(B) may be earbuds or any other suitable type of headphone or speaker.

The configuration of acoustic transducers 2220 of the microphone array may vary. While augmented-reality system 2200 is shown in FIG. 22 as having ten acoustic transducers 2220, the number of acoustic transducers 2220 may be greater or less than ten. In some embodiments, using higher numbers of acoustic transducers 2220 may increase the amount of audio information collected and/or the sensitivity and accuracy of the audio information. In contrast, using a lower number of acoustic transducers 2220 may decrease the computing power required by an associated controller 2250 to process the collected audio information. In addition, the position of each acoustic transducer 2220 of the microphone array may vary. For example, the position of an acoustic transducer 2220 may include a defined position on the user, a defined coordinate on frame 2210, an orientation associated with each acoustic transducer 2220, or some combination thereof.

Acoustic transducers 2220(A) and 2220(B) may be positioned on different parts of the user’s ear, such as behind the pinna, behind the tragus, and/or within the auricle or fossa. Or, there may be additional acoustic transducers 2220 on or surrounding the ear in addition to acoustic transducers 2220 inside the ear canal. Having an acoustic transducer 2220 positioned next to an ear canal of a user may enable the microphone array to collect information on how sounds arrive at the ear canal. By positioning at least two of acoustic transducers 2220 on either side of a user’s head (e.g., as binaural microphones), augmented-reality device 2200 may simulate binaural hearing and capture a 3D stereo sound field around about a user’s head. In some embodiments, acoustic transducers 2220(A) and 2220(B) may be connected to augmented-reality system 2200 via a wired connection 2230, and in other embodiments acoustic transducers 2220(A) and 2220(B) may be connected to augmented-reality system 2200 via a wireless connection (e.g., a BLUETOOTH connection). In still other embodiments, acoustic transducers 2220(A) and 2220(B) may not be used at all in conjunction with augmented-reality system 2200.

Acoustic transducers 2220 on frame 2210 may be positioned in a variety of different ways, including along the length of the temples, across the bridge, above or below display devices 2215(A) and 2215(B), or some combination thereof. Acoustic transducers 2220 may also be oriented such that the microphone array is able to detect sounds in a wide range of directions surrounding the user wearing the augmented-reality system 2200. In some embodiments, an optimization process may be performed during manufacturing of augmented-reality system 2200 to determine relative positioning of each acoustic transducer 2220 in the microphone array.

In some examples, augmented-reality system 2200 may include or be connected to an external device (e.g., a paired device), such as neckband 2205. Neckband 2205 generally represents any type or form of paired device. Thus, the following discussion of neckband 2205 may also apply to various other paired devices, such as charging cases, smart watches, smart phones, wrist bands, other wearable devices, hand-held controllers, tablet computers, laptop computers, other external compute devices, etc.

As shown, neckband 2205 may be coupled to eyewear device 2202 via one or more connectors. The connectors may be wired or wireless and may include electrical and/or non-electrical (e.g., structural) components. In some cases, eyewear device 2202 and neckband 2205 may operate independently without any wired or wireless connection between them. While FIG. 22 illustrates the components of eyewear device 2202 and neckband 2205 in example locations on eyewear device 2202 and neckband 2205, the components may be located elsewhere and/or distributed differently on eyewear device 2202 and/or neckband 2205. In some embodiments, the components of eyewear device 2202 and neckband 2205 may be located on one or more additional peripheral devices paired with eyewear device 2202, neckband 2205, or some combination thereof.

Pairing external devices, such as neckband 2205, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 2200 may be provided by a paired device or shared between a paired device and an eyewear device, thus reducing the weight, heat profile, and form factor of the eyewear device overall while still retaining desired functionality. For example, neckband 2205 may allow components that would otherwise be included on an eyewear device to be included in neckband 2205 since users may tolerate a heavier weight load on their shoulders than they would tolerate on their heads. Neckband 2205 may also have a larger surface area over which to diffuse and disperse heat to the ambient environment. Thus, neckband 2205 may allow for greater battery and computation capacity than might otherwise have been possible on a stand-alone eyewear device. Since weight carried in neckband 2205 may be less invasive to a user than weight carried in eyewear device 2202, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 2205 may be communicatively coupled with eyewear device 2202 and/or to other devices. These other devices may provide certain functions (e.g., tracking, localizing, depth mapping, processing, storage, etc.) to augmented-reality system 2200. In the embodiment of FIG. 22, neckband 2205 may include two acoustic transducers (e.g., 2220(I) and 2220(J)) that are part of the microphone array (or potentially form their own microphone subarray). Neckband 2205 may also include a controller 2225 and a power source 2235.

Acoustic transducers 2220(I) and 2220(J) of neckband 2205 may be configured to detect sound and convert the detected sound into an electronic format (analog or digital). In the embodiment of FIG. 22, acoustic transducers 2220(I) and 2220(J) may be positioned on neckband 2205, thereby increasing the distance between the neckband acoustic transducers 2220(I) and 2220(J) and other acoustic transducers 2220 positioned on eyewear device 2202. In some cases, increasing the distance between acoustic transducers 2220 of the microphone array may improve the accuracy of beamforming performed via the microphone array. For example, if a sound is detected by acoustic transducers 2220(C) and 2220(D) and the distance between acoustic transducers 2220(C) and 2220(D) is greater than, e.g., the distance between acoustic transducers 2220(D) and 2220(E), the determined source location of the detected sound may be more accurate than if the sound had been detected by acoustic transducers 2220(D) and 2220(E).

Controller 2225 of neckband 2205 may process information generated by the sensors on neckband 2205 and/or augmented-reality system 2200. For example, controller 2225 may process information from the microphone array that describes sounds detected by the microphone array. For each detected sound, controller 2225 may perform a direction-of-arrival (DOA) estimation to estimate a direction from which the detected sound arrived at the microphone array. As the microphone array detects sounds, controller 2225 may populate an audio data set with the information. In embodiments in which augmented-reality system 2200 includes an inertial measurement unit, controller 2225 may compute all inertial and spatial calculations from the IMU located on eyewear device 2202. A connector may convey information between augmented-reality system 2200 and neckband 2205 and between augmented-reality system 2200 and controller 2225. The information may be in the form of optical data, electrical data, wireless data, or any other transmittable data form. Moving the processing of information generated by augmented-reality system 2200 to neckband 2205 may reduce weight and heat in eyewear device 2202, making it more comfortable to the user.

Power source 2235 in neckband 2205 may provide power to eyewear device 2202 and/or to neckband 2205. Power source 2235 may include, without limitation, lithium ion batteries, lithium-polymer batteries, primary lithium batteries, alkaline batteries, or any other form of power storage. In some cases, power source 2235 may be a wired power source. Including power source 2235 on neckband 2205 instead of on eyewear device 2202 may help better distribute the weight and heat generated by power source 2235.

As noted, some artificial-reality systems may, instead of blending an artificial reality with actual reality, substantially replace one or more of a user’s sensory perceptions of the real world with a virtual experience. One example of this type of system is a head-worn display system, such as virtual-reality system 2300 in FIG. 23, that mostly or completely covers a user’s field of view. Virtual-reality system 2300 may include a front rigid body 2302 and a band 2304 shaped to fit around a user’s head. Virtual-reality system 2300 may also include output audio transducers 2306(A) and 2306(B). Furthermore, while not shown in FIG. 23, front rigid body 2302 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 2200 and/or virtual-reality system 2300 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user’s refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer’s eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 2200 and/or virtual-reality system 2300 may include microLED projectors that project light (using, e.g., a waveguide) into display devices, such as clear combiner lenses that allow ambient light to pass through. The display devices may refract the projected light toward a user’s pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 2200 and/or virtual-reality system 2300 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user’s real-world experience in a variety of contexts and environments. For instance, artificial-reality systems may assist or extend a user’s perception, memory, or cognition within a particular environment. Some systems may enhance a user’s interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user’s artificial-reality experience in one or more of these contexts and environments and/or in other contexts and environments.

The process parameters and sequence of the steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a fluid layer that comprises or includes 1,3-bis(phenylthio)benzene include embodiments where a fluid layer consists essentially of 1,3-bis(phenylthio)benzene and embodiments where a fluid layer consists of 1,3-bis(phenylthio)benzene.

What is claimed is:

1. A fluidic optical element comprising:
a fluid bilayer including a first fluid layer and a second fluid layer defining a fluid boundary therebetween; and
a first electrode layer disposed over a surface of the fluid bilayer.

2. The fluidic optical element of claim 1, wherein the first fluid layer comprises a first liquid selected from the group consisting of a polyphenylether, 1,3-bis(phenylthio)benzene, and silicone oil and the second fluid layer comprises a second liquid selected from the group consisting of water and silicone oil.

3. The fluidic optical element of claim 2, wherein the first liquid and the second liquid are substantially immiscible.

4. The fluidic optical element of claim 2, wherein a refractive index difference between the first liquid and the second liquid is at least approximately 0.1.

5. The fluidic optical element of claim 1, wherein at least one of the first fluid layer and the second fluid layer comprises a surfactant.

6. The fluidic optical element of claim 1, further comprising a partition structure separating the fluid bilayer into a plurality of fluid chambers.

7. The fluidic optical element of claim 1, wherein the first electrode layer is optically transparent.

8. The fluidic optical element of claim 1, wherein a thickness of the first electrode layer ranges from approximately 10 nm to approximately 50 nm.

9. The fluidic optical element of claim 1, wherein the first electrode layer directly overlies the first fluid layer.

10. The fluidic optical element of claim 1, wherein the first electrode layer comprises a continuous coating.

11. The fluidic optical element of claim 1, wherein the first electrode layer comprises a segmented coating.

12. The fluidic optical element of claim 1, wherein the first electrode layer is configured as an array of discrete electrode segments.

13. The fluidic optical element of claim 12, wherein two or more of the electrode segments are independently connected to a respective voltage source.

14. The fluidic optical element of claim 12, wherein floating electrode segments have areal dimensions less than areal dimensions of electrode segments connected to a voltage source.

15. The fluidic optical element of claim 1, further comprising a solid dielectric layer disposed over the first electrode layer.

16. The fluidic optical element of claim 1, further comprising a second electrode layer disposed over a surface of the fluid bilayer opposite to the first electrode layer.

17. The fluidic optical element of claim 16, wherein the second electrode layer is configured as an array of discrete electrode segments.

18. The fluidic optical element of claim 1, wherein the fluid bilayer is disposed between transparent substrates.

19. A fluidic optical element comprising:
a primary electrode;
a secondary electrode overlapping at least a portion of the primary electrode; and
a fluid bilayer including a first fluid layer and a second fluid layer disposed between and abutting the primary electrode and the secondary electrode.

20. A method comprising:
forming a fluid bilayer between a primary electrode and a secondary electrode, the fluid bilayer including a first fluid layer and a second fluid layer defining a fluid boundary therebetween having a first shape; and
applying a voltage across the fluid bilayer in an amount effective to change the first shape of the fluid boundary to a second shape and modify an optical response of the fluid bilayer.
